(19) United States
(12) Patent Application Publication
(10) Pub. No.: US 2006/0124733 A1
(43) Pub. Date: Jun. 15, 2006

(54) System and method for vending products at a vending site

(76) Inventor: David K. Matthews, Fort Worth, TX (US)

Correspondence Address: LAW OFFICE OF DONALD D. MONDUL, 3060 Bonsai Drive, Plano, TX, 75093, US

(21) Appl. No.: 11/011,803

(22) Filed: Dec. 14, 2004

(51) Int. Cl. G06F 7/08; G06K 15/00

(52) U.S. Cl. 235/381; 235/383

(57) ABSTRACT

A system for vending products at a vending site includes: (a) display sites displaying products at the vending site; (b) a code reader located at each display site; (c) an initiator associated with each display site; (d) a communication connection between each display site and at least one data collection locus; and (e) coded units used by shoppers; each coded unit being associated with a respective shopper. Each shopper indicating interest in a product by locating a coded unit within a predetermined range of a code reader at a display site for the product permitting wireless linking between the code reader and the coded unit. Actuation of an initiator at the display site while the coded unit is within the predetermined range effects communicating of predetermined information about the product and about the shopper via the communication connection to the at least one data collection locus.

### BACKGROUND OF THE INVENTION

The present invention is directed to vending systems and methods, and especially to vending systems and methods for use in retail vending.

So called “bricks-and-mortar” shopping facilities have been known at least for many decades. So called electronic shopping is a relatively new phenomenon usually effected via a network, such as the Internet. Electronic shopping has some advantages over shopping at bricks-and-mortar facilities including, for example, eliminating opportunities for shoplifting products, eliminating breakage of products made available for self-service selection, simplifying inventory procedures, and other advantages. However, electronic shopping, among other disadvantages, does not permit shoppers to handle or try out products before purchase, does not permit shoppers to immediately possess a product after purchasing it, and often does not permit viewing and trying competing products before purchasing one.

Some stores (i.e., bricks-and-mortar facilities) have installed dedicated network or Internet communication terminals to facilitate electronic shopping. Other stores have installed a dedicated telephone line to facilitate placing catalog orders via telephone. However, these efforts at incorporating “e-business” (i.e., electronic business) capabilities generally mean that a company must maintain parallel e-business and bricks-and-mortar store facilities. All of the problems associated with operating a store facility are still experienced by shoppers and by retailers—keeping inventory on shelves, breakage of inventory (as, for example, by dropping), shoplifting and other problems associated with maintaining products available for self-serve shopping by customers.

There is a need for a system and method for vending products at a vending site such as a store facility that employs electronic business techniques to reduce problems experienced in operating a self-service store.

### SUMMARY OF THE INVENTION

A system for vending products at a vending site includes: (a) display sites displaying products at the vending site; (b) a code reader located at each display site; (c) an initiator associated with each display site; (d) a communication connection between each display site and at least one data collection locus; and (e) coded units used by shoppers; each coded unit being associated with a respective shopper. Each shopper indicating interest in a product by locating a coded unit within a predetermined range of a code reader at a display site for the product permitting wireless linking between the code reader and the coded unit. Actuation of an initiator at the display site while the coded unit is within the predetermined range effects communicating of predetermined information about the product and about the shopper via the communication connection to the at least one data collection locus.

A method for effecting vending for a plurality of products at at least one vending site includes the steps of: (a) in no particular order: (1) providing a plurality of display sites at each respective vending site of the at least one vending site; each respective display site of the plurality of display sites effecting display of at least one product of the plurality of products; (2) providing a respective code reader unit located with selected display sites of the plurality of display sites; (3) providing at least one functional initiator associated with each the selected display site; (4) providing a communication connection between each the selected display site and at least one data collection locus; and (5) providing a plurality of coded units used by a plurality of shoppers; each respective coded unit of the plurality of coded units being associated with a respective shopper of the plurality of shoppers; (b) locating the respective coded unit within a predetermined range of the selected display site for a respective product of interest of the plurality of products; the predetermined range permitting wireless linking between the code reader unit at the selected display site and the coded unit; and (c) actuating at least one functional initiator of the at least one functional initiator at the selected display site while the respective coded unit is within the predetermined range to effect communicating of predetermined information about the respective product and about the respective shopper via the communication connection to the at least one data collection locus.

It is, therefore, an object of the present invention to provide a system and method for vending products at a vending site such as a store facility that employs electronic business techniques to reduce problems experienced in operating a self-service store.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a perspective schematic illustration of a product display employing the present invention.

FIG. 2 is a schematic diagram of a representative store layout employing the present invention.

FIG. 3 is a schematic diagram of a network of stores employing the present invention.

FIG. 4 is a flow diagram illustrating the method of the present invention.

### DETAILED DESCRIPTION OF THE PREFERRED EMBODIMENT

The invention is a system and method for vending a plurality of products at at least one vending site, such as a self-service store facility. The employment of the invention establishes an arrangement for a store facility in which a customer is provided with an identification accessory, preferably having a radio frequency identification (RFID) capability. A preferred embodiment would be a give-away token, such as a flashlight, for keeping on one's keychain—the token having an RFID tag adhered to the inside of its case, on an internal circuit board or otherwise affixed with the token.

The store facility has shelves displaying samples of products at display sites for inspection by customers. Inventory is preferably maintained at a site or in a storeroom not accessible by customers. Near each sample product display are functional initiators, preferably embodied in a button labeled “BUY” and a button labeled “MORE INFO”. Also near each product display is a code reader, preferably embodied in an RFID reader device.

A customer wishing to either buy a product or wishing to learn more about a product may pass his RFID tag (token) near the RFID reader device adjacent the product of interest. Then the customer pushes an appropriate button indicating a desire to “BUY” or indicating a desire for “MORE INFO”. This indication, the customer's identification and the product designation are provided to a central facility (e.g., a computer, an off-site warehouse or another facility) and maintained at least for the remainder of the customer's visit. Information may be maintained for longer than the customer's visit for market research or for other purposes.

Providing information to the central facility may be carried out using one or more of a public switched telephone network (PSTN), private branch exchange network, local area network (LAN), wireless local area network (WLAN), wide area network (WAN), satellite communications, the Internet or a combination of these or other communication links.

When the customer has finished perusing the products and indicating his desires, the customer goes to a customer-interactive information position that is preferably connected with the central facility and with the store product indicator buttons. Connection between the customer information position and the display sites for products may be effected any manner, including manners described above in connection with providing information to the central facility.

The customer again passes his RFID tag near an RFID reader device at the customer information position and his product selection indicators (e.g., “BUY” and “MORE INFO” selections) appear on a display. The customer may amend his selections, if he wishes, and then he may view a video or a data sheet or other information for his “MORE INFO” selections. Copies of the videos, data sheets or other information may be provided to the customer at the customer information position or may be e-mailed to the customer, at the election of the customer.

Once the customer is ready to check out he may proceed to a checkout counter in the store facility where an attendant will already have collected his purchases for checkout. The customer's purchases will be ready for pickup because the store's RFID reader system and the central facility will have provided the customer's “BUY” selections ahead of the customer's arrival at the checkout counter. Alternatively, the customer may indicate (e.g., while at the customer information position) that he wishes some or all of this selections to be shipped to his home or to another address. An additional button may be provided adjacent displayed products or at the customer information position for this indication, if desired. In any event, by the time the customer arrives at the checkout counter, his purchases are bagged and a sales check is already awaiting him.

Using the system and method of the present invention, a retailer may offer otherwise “Internet Only” products to store visitors also. Such products would not available for pick-up or take-home, but would be available for shipping to desired address.

It is anticipated that certain information regarding a customer may be registered at a central locus for use in servicing the customer. This information may include some or all of name, address, phone number(s), e-mail address, age, family members, and similar contact, marketing or demographic information.

The particular arrangement of buttons is not critical to the patentability of the present invention. Further, the arrangement by which a code reading capability is provided for each product sample is not critical to the patentability of the invention. It is preferred that the code reading capability be embodied in an RFID reading capability. There may be a single code reader device for each shelf. A single code reader device could serve a given store, and individual display sites may be polled using a time-sharing or similar arrangement. Individual product samples may be identified by a code relating to its respective position on a particular shelf. Thus, when a customer waves his RFID tag near a code reader station next to a product the code reader station may pass on the RFID of the customer as well as a coded indication indicating which station has read the customer RFID tag.

Among the advantages provided by the present invention are better inventory control, reduced shoplifting exposure, reduced clutter in a store, less opportunity for breakage by store employees or by customers, and orders are collected and inventory is amended at the time the items are selected for purchase.

An attempt to address this situation is disclosed in U.S. Patent Publication 2002/0065680 of May 30, 2002 to Kojima et al. (hereinafter referred to as “Kojima”). Kojima discloses a system in which a customer entering a merchandise retail store borrows a radio frequency identification (RFID) portable terminal at the store entrance. The customer selects a sample commodity from a store sales area and a commodity code is read out from a wireless tag in a wireless tag label to the RFID portable terminal. The commodity code is stored in the RFID portable terminal, which simultaneously relays that information to the outside. An information processing apparatus in the store receives this message and prepares the commodity that the customer wishes to purchase. The customer returns the RFID portable terminal to the sales counter, settles payment and receives his wrapped commodity.

In order to perform as disclosed, Kojima's RFID terminal requires a data storage capability, a data transmitter and a power source. These requirements result in a RFID terminal of significant cost, and therein seemingly lies Kojima's provision that the RFID terminals are loaned to customers as they enter a store and are returned by customers as they leave the store.

The present invention, in significant contrast, provides for a coded unit, preferably embodied in a RFID code unit, that merely identifies the customer or shopper. When the shopper indicates an interest in a product, as by indicating “BUY” or “MORE INFO”, the present invention associates the shopper with an indicated product of interest. No data storage is performed by the unit carried by a shopper using the present invention. No data transmission relating to the product of interest is carried out by the unit carried by a shopper using the present invention. No power source is required for the unit carried by a shopper using the present invention.

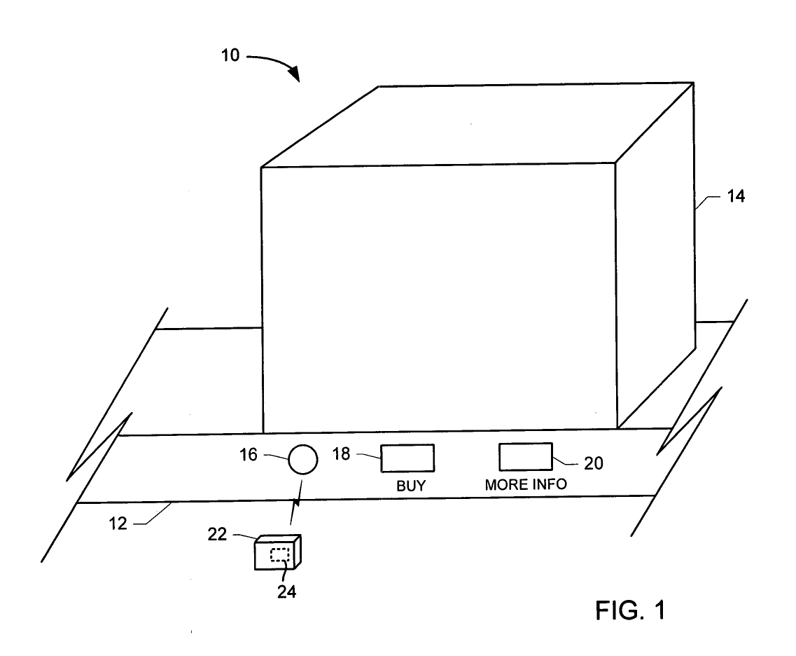

FIG. 1 is a perspective schematic illustration of a product display employing the present invention. In FIG. 1, a display site 10 for use in a system for effecting vending for a plurality of products (not shown in FIG. 1) includes a shelf 12 supporting a product 14 displayed for viewing or trying by a customer or shopper (not shown in FIG. 1). Shelf 12 includes a code reader unit 16 and functional initiators 18, 20. Functional initiators 18, 20 are preferably embodied in buttons or flat-panel press-actuated initiator units.

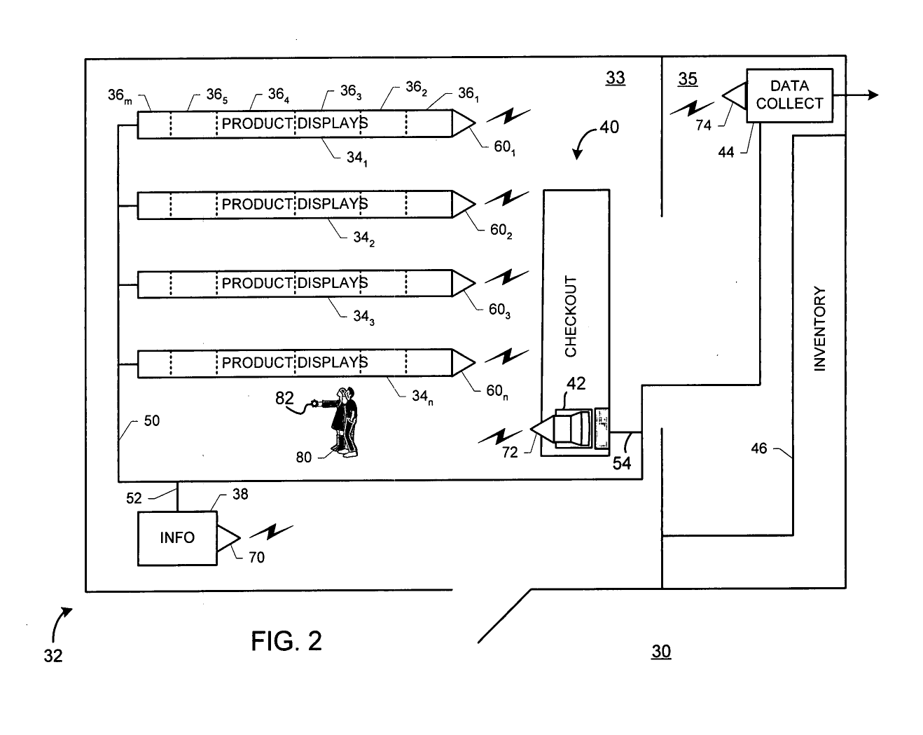

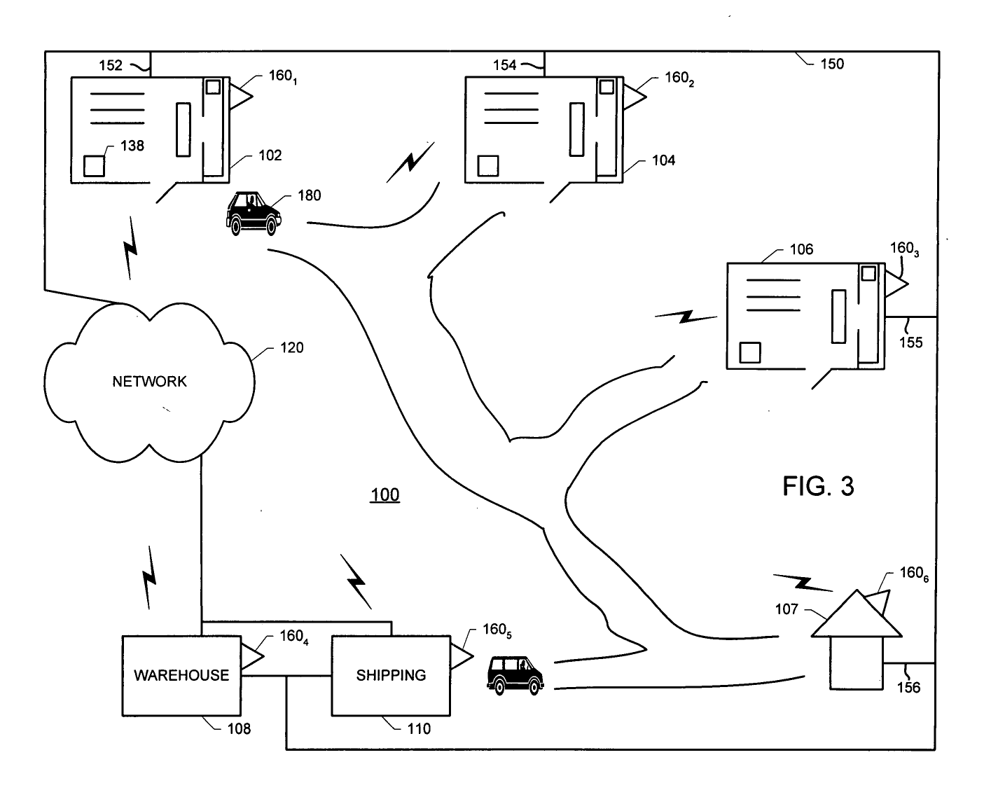

A coded unit 22 is carried by a customer (not shown in FIG. 1) and may be used to couple with coded reader unit 16 by bringing coded unit 22 within a predetermined range of coded reader unit 16. Coded unit 22 may be embodied in any of several configurations including, by way of example and not by way of limitation, a coded unit loaned to a customer when entering a vending premise and left at the vending premise when departing or a coded unit retained by a customer. In a preferred embodiment, coded unit 22 is configured as a token or other kept unit maintained in the customer's possession such as, by way of example and not by way of limitation, a flashlight, a calculator, a keychain fob or a similar kept unit. Coded unit 22 serves to identify a particular customer to coded reader 16 and thence to a system for effecting vending (described in greater detail in connection with FIGS. 2 and 3). In its preferred embodiment, coded unit 22 contains or bears a radio frequency identification (RFID) unit or chip 24 for effecting coding. This preferred embodiment including an RFID chip 24 is particularly advantageous because no power source, such as a battery or solar panel, is required for RFID chip 24 to carry out its identification function vis-à-vis coded reader unit 16 and its associated system for effecting vending (described in greater detail in connection with FIGS. 2 and 3).

Functional initiators 18, 20 respond to actuation by a customer when coded unit 22 is within a predetermined range of coded reader unit 16 to convey a predetermined indication to a system for effecting vending (described in greater detail in connection with FIGS. 2 and 3). In a preferred embodiment functional initiator 18 conveys an indication of a desire to buy product 14 when actuated by a customer and functional initiator 20 conveys an indication of a desire to receive more information about product 14 when actuated by a customer, so long as coded unit 22 is within a predetermined range of coded reader unit 16.

FIG. 2 is a schematic diagram of a representative store layout employing the present invention. In FIG. 2, a local system 30 for effecting vending for a plurality of products (not shown in detail in FIG. 2) at a vending site 32. Vending site 32 includes a front room 33 and a back room 35. Front room 33 contains a plurality of display shelves 34₁, 34₂, 34₃, 34ₙ. The indicator “n” is employed to signify that there can be any number of shelves in local vending system 30. The inclusion of four shelves 34ₙ in FIG. 2 is illustrative only and does not constitute any limitation regarding the number of shelves that may be included in the vending system of the present invention. Each shelf 34ₙ includes at least one display site for displaying a respective sample product.

In FIG. 2, only shelf 34₁ is illustrated as having display sites 36₁, 36₂, 36₃, 36₄, 36₅, 36ₘ in order to avoid cluttering FIG. 2. Any of shelves 34₁, 34₂, 34₃, 34ₙ may have any number of display sites 36ₘ. Further, each shelf 34ₙ may be multi-tiered, and the various shelves 34ₙ do not necessarily each have the same number of display sites 36ₘ. Still further, the various display sites 36ₘ do not need to be the same size. The indicator “m” is employed to signify that there can be any number of display sites on a respective shelf 34ₙ. The inclusion of six display sites 36ₘ on shelf 34₁ in FIG. 2 is illustrative only and does not constitute any limitation regarding the number of display sites that may be included on a respective shelf 34ₙ of the present invention.

Local vending system 30 further includes in front room 33, a back room 35, a shopper-interactive information locus 38 and a check-out locus 40. Check-out locus 40 includes a point-of-sale register 42. Local vending system 30 further includes in back room 35 a data collection locus 44, preferably embodied in a computer device, and inventory 46 of products sold at vending site 32 and available for customers to take with them when they leave vending site 32.

A communication connection is established among display sites 36m on various shelves 34n, shopper-interactive information locus 38, point-of-sale register 42 and data collection locus 44. The communication connection may be established by any of a variety of means, including by way of example and not by way of limitation, one or more of a local area network (LAN) represented by connecting lines 50, 52, 54, or a wireless local area network (WLAN). A WLAN is represented in FIG. 2 by a plurality of transceiver antennas 60₁, 60₂, 60₃, 60ₙ installed in respective shelves 34₁, 34₂, 34₃, 34ₙ communicatingly linked with shopper-interactive information locus 38 via a transceiver antenna 70, communicatingly linked with point-of-sale register 42 via a transceiver antenna 72 and communicatingly linked with data collection locus via a transceiver antenna 74. Connections among various components (i.e., display sites 36ₘ, shelves 34ₙ, shopper-interactive information locus 38, point-of-sale register 42 and data collection locus 44) of local system 30 may be established by one or both of a LAN configuration and a WLAN configuration. Further, connection among various components of local system 30 may also be established using direct connections among components or a wide area network (WAN). The WAN may incorporate a public switched telephone network (PSTN), a private branch exchange (PBX) network, a private network, the Internet or another network. Communication among the various components of local system 30 may include any of these communication technologies alone or in any combination.

When a shopper 80 shops in vending site 32 carrying a coded unit 82, shopper 80 may identify a product of interest at a display site on a shelf. Shopper 80 may situate coded unit 82 within a predetermined range of the display site associated with the product of interest to communicatingly link coded unit 82 and a code reading unit associated with the display site at which the product of interest is displayed (see FIG. 1). Shopper 80 may then actuate one or both of functional initiators 16, 18 to indicate a desire to purchase the product of interest or to receive additional information regarding the product of interest, or both. Coded unit 82 uniquely identifies shopper 80 as having initiated the indication.

Shopper 80 may indicate a desire to buy or learn more about more than one product of interest by repeating the procedure at other display sites associated with other products of interest. When shopper 80 has completed shopping, shopper 80 may proceed to shopper-interactive information locus 38 to review a display summarizing the various indications made by shopper 80 in connection with various products. Choices may be offered to shopper 80 such as, by way of example and not by way of limitation, printing further information on-site for review and taking home, providing further information to an e-mail address indicated by shopper 80, arranging for selected products indicated for “BUY” to be prepared for pickup at checkout locus 40, arranging for selected products indicated for “BUY” to be delivered to an address indicated by shopper 80, or other choices. An opportunity may also be provided to shopper 80 at shopper-interactive information locus 38 to amend indications made while shopping, such as providing an opportunity to shopper 80 to indicate “BUY” for a product previously indicated for “MORE INFO” while shopping.

Once shopper 80 has completed reviewing or changing the selected product list and arrangements relating to selected products, shopper 80 may proceed to checkout locus 40 to pay for items indicated as “BUY” and to retrieve items at checkout locus 40 indicated for such treatment. By having earlier indicated “BUY” decisions regarding products, an attendant or a machine or both may prepare a sales statement and receipt for shopper 80 before shopper 80 arrives at checkout locus 40. Time is provided for retrieving products from inventory 46 and having the bought products indicated for taking with ready for pickup by shopper 80 as shopper 80 arrives at checkout locus 40.

FIG. 3 is a schematic diagram of a network of stores employing the present invention. In FIG. 3, a network 100 includes stores 102, 104, 106, a warehouse 108 and a shipping facility 110. Each of stores 102, 104, 106 is generally similar to vending site 32 (FIG. 2). Stores 102, 104, 106, warehouse 108 and shipping facility 110 are coupled in network 110 by any of a variety of means, including by way of example and not by way of limitation, one or more of a local area network (LAN) represented by connecting lines 150, 152, 154, 155. A connection may also be established via a connecting line 156 with a customer's home 107. A wireless local area network (WLAN) may also couple stores 102, 104, 106, warehouse 108 and shipping facility 110, as well as customer home 107. A WLAN is represented in FIG. 3 by a plurality of transceiver antennas 160₁, 160₂, 160₃, 160₄, 160₅, 160₆ installed in stores 102, 104, 106, warehouse 108, shipping facility 110 and customer home 107. Connections among stores 102, 104, 106, warehouse 108, shipping facility 110 and customer home 107 may be established by one or both of a LAN configuration and a WLAN configuration. Further, connection among the various components of network 100 (e.g., stores 102, 104, 106, warehouse 108, shipping facility 110 and customer home 107) may also be established using direct connections among components or a wide area network (WAN). The WAN may incorporate a public switched telephone network (PSTN), a private branch exchange (PBX) network, a private network, the Internet or another network, as represented by network 120. Communication among the various components of local network 100 may include any of these communication technologies alone or in any combination.

A shopper 180 may shop in store 102 as described in detail in connection with vending site 32 (FIG. 2) using a coded unit (not shown in detail in FIG. 3) to identify himself and indicating “MORE INFO” or “BUY” for selected products at store 102. Shopper 180 may use a shopper-interactive information locus 138 at store 102 to direct that products selected for “BUY” at store 102 be delivered to shopper's home 107 (or to another location not illustrated in FIG. 3) from warehouse 108 or from shipping facility 110. Warehouse 108 may direct shipment from shipping facility 110. Alternately, shopper 180 may be offered an option to pick up the bought product at one of stores 104, 106.

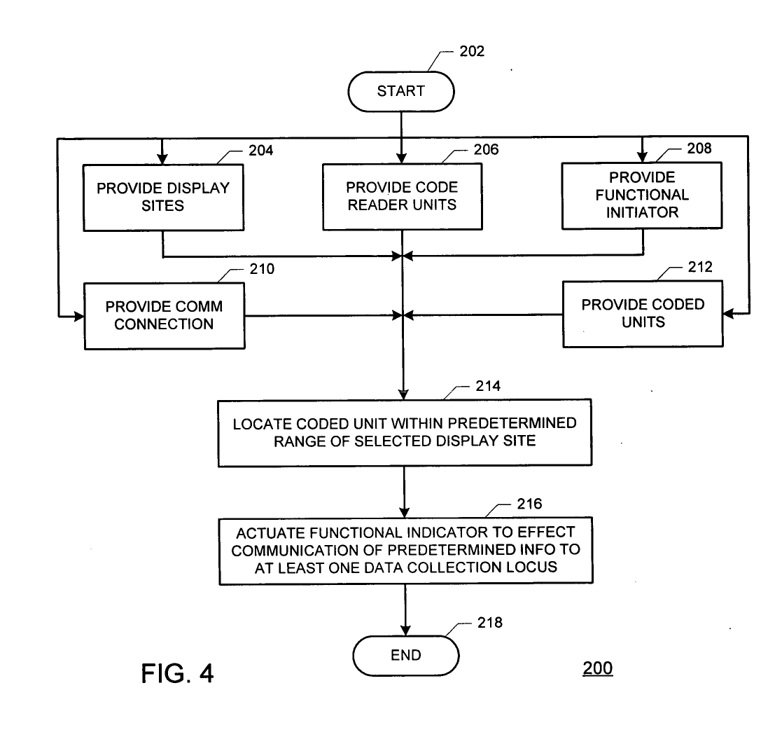

FIG. 4 is a flow diagram illustrating the method of the present invention. In FIG. 4, a method 200 for effecting vending for a plurality of products at at least one vending site begins at a START locus 202. Method 200 continues with the step of, in no particular order: (1) providing a plurality of display sites at each respective vending site of the at least one vending site; each respective display site of the plurality of display sites effecting display of at least one product of the plurality of products, as indicated by a block 204; (2) providing a respective code reader unit located with selected display sites of the plurality of display sites, as indicated by a block 206; (3) providing at least one functional initiator associated with each selected display site, as indicated by a block 208; (4) providing a communication connection between each selected display site and at least one data collection locus, as indicated by a block 210; and (5) providing a plurality of coded units used by a plurality of shoppers as indicated by a block 212. Each respective coded unit of the plurality of coded units is associated with a respective shopper of the plurality of shoppers.

Method 200 continues with the step of locating the respective coded unit within a predetermined range of the selected display site for a respective product of interest of the plurality of products, as indicated by a block 214. The predetermined range permits wireless linking between the code reader unit at the selected display site and the coded unit.

Method 200 continues with the step of actuating at least one functional initiator at the selected display site while the respective coded unit is within the predetermined range to effect communicating of predetermined information about the respective product and about the respective shopper via the communication connection to the at least one data collection locus, as indicated by a block 216. Method 200 terminates at an END locus 218.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A system for effecting vending for a plurality of products at at least one vending site; the system comprising:
(a) a plurality of display sites at each respective vending site of said at least one vending site; each respective display site of said plurality of display sites effecting display of at least one product of said plurality of products;
(b) a respective code reader unit located with selected display sites of said plurality of display sites;
(c) at least one functional initiator associated with each said selected display site;
(d) a communication connection between each said selected display site and at least one data collection locus; and
(e) a plurality of coded units used by a plurality of shoppers; each respective coded unit of said plurality of coded units being associated with a respective shopper of said plurality of shoppers;
each said respective shopper indicating interest in a respective product of said plurality of products by locating said respective coded unit within a predetermined range of said selected display site for said respective product; said predetermined range permitting wireless linking between said code reader unit at said selected display site and said coded unit; actuation of at least one functional initiator of said at least one functional initiator at said selected display site by said respective shopper while said respective coded unit is within said predetermined range effecting communicating of predetermined information about said respective product and about said respective shopper via said communication connection to said at least one data collection locus.

2. A system for effecting vending for a plurality of products at at least one vending site as recited in claim 1 wherein said at least one functional initiator includes a first functional initiator for indicating a desire to buy said at least one product displayed at said selected display site.

3. A system for effecting vending for a plurality of products at at least one vending site as recited in claim 1 wherein at least one functional initiator includes a first functional initiator for indicating a desire to buy said at least one product displayed at said selected display site and a second functional initiator for indicating a desire to receive more information regarding said at least one product displayed at said selected display site.

4. A system for effecting vending for a plurality of products at at least one vending site as recited in claim 1 wherein said communication connection is comprised of at least one of a local area network, a wireless local area network, direct connection between each said selected display site and said at least one data collection locus, a wide area network and the Internet.

5. A system for effecting vending for a plurality of products at at least one vending site as recited in claim 1 wherein said at least one data collection locus includes at least one of a shopper-interactive locus within said respective vending site, an inventory control locus, a shipping control locus and a shopper check-out locus in said respective vending site.

6. A system for effecting vending for a plurality of products at at least one vending site as recited in claim 1 wherein said plurality of coded units is a plurality of radio frequency identification units.

7. A system for effecting vending for a plurality of products at at least one vending site as recited in claim 6 wherein said selected radio frequency identification units are kept by a respective shopper after departing said respective vending site.

8. A system for effecting vending for a plurality of products at at least one vending site as recited in claim 3 wherein said communication connection is comprised of at least one of a local area network, a wireless local area network, direct connection between each said selected display site and said at least one data collection locus, a wide area network and the Internet.

9. A system for effecting vending for a plurality of products at at least one vending site as recited in claim 8 wherein said at least one data collection locus includes at least one of a shopper-interactive locus within said respective vending site, an inventory control locus, a shipping control locus and a shopper check-out locus in said respective vending site.

10. A system for effecting vending for a plurality of products at at least one vending site as recited in claim 9 wherein said plurality of coded units is a plurality of radio frequency identification units.

11. A system for effecting vending for a plurality of products at at least one vending site as recited in claim 10 wherein selected radio frequency identification units are kept by a respective shopper after departing said respective vending site.

12. A system for effecting vending for a plurality of products at at least one vending site as recited in claim 5 wherein said plurality of coded units is a plurality of radio frequency identification units.

13. A merchandise retail vending system comprising:
(a) a plurality of portable coded units for holding by a shopper; each respective portable coded unit of said plurality of portable coded units being associated with a respective said shopper;
(b) a plurality of sample products representing said merchandise; said plurality of sample products being displayed at a plurality of display loci;
(c) a code reader unit situated in association with respective display loci of said plurality of display loci; each respective said code reader unit being capable of reading information from said plurality of portable coded units within a predetermined range;
(d) at least one initiator unit associated with each said respective display locus; each said at least one initiator unit and each said respective code reader unit cooperating to effect providing predetermined information to at least one information processing apparatus when a respective shopper actuates a respective initiator unit of said at least one initiator unit while holding said respective coded unit within said predetermined range.

14. A merchandise retail vending system as recited in claim 13 wherein said at least one initiator unit includes a first initiator unit for indicating a desire to buy said merchandise represented by said sample product displayed at said respective display locus.

15. A merchandise retail vending system as recited in claim 13 wherein said at least one initiator unit includes a first initiator unit for indicating a desire to buy said merchandise represented by said sample product displayed at said respective display locus and a second initiator unit for indicating a desire to receive more information regarding said merchandise represented by said sample product displayed at said respective display locus.

16. A merchandise retail vending system as recited in claim 13 wherein said providing predetermined information is effected using at least one of a local area network, a wireless local area network, direct connection between each said selected display site and said at least information processing apparatus, a wide area network and the Internet.

17. A merchandise retail vending system as recited in claim 13 wherein said at least one information processing apparatus includes at least one of a shopper-interactive information processing apparatus, an inventory control information processing apparatus, a shipping control information processing apparatus and a shopper check-out information processing apparatus.

18. A merchandise retail vending system as recited in claim 13 wherein said plurality of coded units is a plurality of radio frequency identification units.

19. A merchandise retail vending system as recited in claim 18 wherein selected said radio frequency identification units are kept by a respective shopper after departing said respective vending site.

20. A merchandise retail vending system as recited in claim 13 wherein said providing predetermined information is effected using at least one of a local area network, a wireless local area network, direct connection between each said selected display site and said at least information processing apparatus, a wide area network and the Internet.

21. A merchandise retail vending system as recited in claim 20 wherein said at least one information processing apparatus includes at least one of a shopper-interactive information processing apparatus, an inventory control information processing apparatus, a shipping control information processing apparatus and a shopper check-out information processing apparatus.

22. A merchandise retail vending system as recited in claim 17 wherein said plurality of coded units is a plurality of radio frequency identification units.

23. A merchandise retail vending system as recited in claim 20 wherein said plurality of coded units is a plurality of radio frequency identification units.

24. A method for effecting vending for a plurality of products at at least one vending site; the method comprising the steps of:
(a) in no particular order:
(1) providing a plurality of display sites at each respective vending site of said at least one vending site; each respective display site of said plurality of display sites effecting display of at least one product of said plurality of products;
(2) providing a respective code reader unit located with selected display sites of said plurality of display sites;
(3) providing at least one functional initiator associated with each said selected display site;
(4) providing a communication connection between each said selected display site and at least one data collection locus; and
(5) providing a plurality of coded units used by a plurality of shoppers; each respective coded unit of said plurality of coded units being associated with a respective shopper of said plurality of shoppers;
(b) locating said respective coded unit within a predetermined range of said selected display site for a respective product of interest of said plurality of products; said predetermined range permitting wireless linking between said code reader unit at said selected display site and said coded unit; and
(c) actuating at least one functional initiator of said at least one functional initiator at said selected display site while said respective coded unit is within said predetermined range to effect communicating of predetermined information about said respective product and about said respective shopper via said communication connection to said at least one data collection locus.

25. A method for effecting vending for a plurality of products at at least one vending site as recited in claim 24 wherein said at least one functional initiator includes a first functional initiator for indicating a desire to buy said at least one product displayed at said selected display site.

26. A method for effecting vending for a plurality of products at at least one vending site as recited in claim 24 wherein at least one functional initiator includes a first functional initiator for indicating a desire to buy said at least one product displayed at said selected display site and a second functional initiator for indicating a desire to receive more information regarding said at least one product displayed at said selected display site.

27. A method for effecting vending for a plurality of products at at least one vending site as recited in claim 24 wherein said communication connection is comprised of at least one of a local area network, a wireless local area network, direct connection between each said selected display site and said at least one data collection locus, a wide area network and the Internet.

28. A method for effecting vending for a plurality of products at at least one vending site as recited in claim 24 wherein said at least one data collection locus includes at least one of a shopper-interactive locus within said respective vending site, an inventory control locus, a shipping control locus and a shopper check-out locus in said respective vending site.

29. A method for effecting vending for a plurality of products at at least one vending site as recited in claim 24 wherein said plurality of coded units is a plurality of radio frequency identification units.

30. A method for effecting vending for a plurality of products at at least one vending site as recited in claim 29 wherein said selected radio frequency identification units are kept by a respective shopper after departing said respective vending site.

31. A method for effecting vending for a plurality of products at at least one vending site as recited in claim 26 wherein said communication connection is comprised of at least one of a local area network, a wireless local area network, direct connection between each said selected display site and said at least one data collection locus, a wide area network and the Internet.

32. A method for effecting vending for a plurality of products at at least one vending site as recited in claim 31 wherein said at least one data collection locus includes at least one of a shopper-interactive locus within said respective vending site, an inventory control locus, a shipping control locus and a shopper check-out locus in said respective vending site.

33. A method for effecting vending for a plurality of products at at least one vending site as recited in claim 32 wherein said plurality of coded units is a plurality of radio frequency identification units.

34. A method for effecting vending for a plurality of products at at least one vending site as recited in claim 33 wherein selected radio frequency identification units are kept by a respective shopper after departing said respective vending site.

35. A method for effecting vending for a plurality of products at at least one vending site as recited in claim 28 wherein said plurality of coded units is a plurality of radio frequency identification units.
